(19) United States
(12) Patent Application Publication
(10) Pub. No.: US 2013/0152058 A1
(43) Pub. Date: Jun. 13, 2013

(54) Method for Translating a Control Program in an Automation Language into an Intermediate Language

(71) Applicant: Siemens Aktiengesellschaft, Muenchen (DE)

(72) Inventor: Axel SCHMUCK, Karlsruhe (DE)

(73) Assignee: Siemens Aktiengesellschaft, Muenchen (DE)

(21) Appl. No.: 13/705,826

(22) Filed: Dec. 5, 2012

(30) Foreign Application Priority Data
Dec. 7, 2011 (EP) EP11192361.1

(51) Int. Cl. G06F 9/45

(52) U.S. Cl. CPC G06F 8/40
USPC 717/137

(57) ABSTRACT

A method for translating a control program in an automation language into an intermediate language, wherein the control program comprises a plurality of basic operations that are each mapped to a respective sequence of instructions in the intermediate language, where a specification database comprising a respective transformation rule for at least a multiplicity of basic operations in the automation language is utilizable in a control program is accessed to translate the control program into the intermediate language, the transformation rule allows an input parameter list to be processed, and if the transformation rule is called with an input parameter list having a plurality of input parameters, unlimited in the transformation rule, the transformation rule defines the inclusion of a further transformation rule. The further transformation rule defines a recursive inclusion of the further transformation rule according to a number of the input parameters.

### BACKGROUND OF THE INVENTION

1. Field of the Invention

The invention relates to a method for automatically translating a control program in an automation language into an intermediate language and to a computer program which operates in accordance with the method and, more particularly, to a development environment for creating and maintaining control programs as an automation solution for a technical process to be controlled and/or monitored, and a device in the form of or in the style of a programming device on which such a computer program/such a development environment is or can be executed.

2. Description of the Related Art

In order to create control programs for controlling and/or monitoring technical processes (automation solution), it is known that a programmer creates his respective control program in an editor that is part of a development environment, for example. In this case, the programmer uses, inter alia, basic operations that are offered by the respective automation language (programming language). When the creation of the control program has been concluded, the program is translated into executable code. When translating the created control program into executable code, provision is occasionally made for the created control program to be converted into a simple intermediate language in a first step, i.e., a representation that is also referred to as an intermediate representation in the technical terminology. This facilitates the production of executable code for different processors of the respective automation devices, i.e., devices such as programmable logic controllers, decentralized field devices or drive controllers, on which the control program for controlling the respective technical process is executed.

In this case, the basic operations contained in the control program must be mapped to a sequence of instructions in the intermediate language, i.e., a basic operation is converted into at least one instruction in the intermediate language in each case. When translating the program into the intermediate language, a functionality provided for this purpose, i.e., a compiler, for example, recognizes a basic operation and transforms the latter into a corresponding sequence of instructions in the intermediate language. A transformation rule underlying such a conversion is integrated in the compiler.

The disadvantage of this procedure is that new basic operations can be defined and used in the programming language only if the compiler is expanded such that it recognizes a new basic operation and handles it accordingly.

### SUMMARY OF THE INVENTION

It is therefore an object of the present invention to provide a method for automatically translating a control program in an automation language into an intermediate language, which method is distinguished, in this respect, by additional flexibility and, in particular, allows the addition of new basic operations for the automation language and corresponding transformation rules for their conversion into the intermediate language.

This and other objects and advantages are achieved in accordance with the invention by providing a method, wherein the control program comprises a plurality of basic operations and wherein each basic operation is automatically mapped to a sequence of instructions in the intermediate language, provision is made, in order to automatically translate the control program into the intermediate language, for a specification database comprising a respective transformation rule for at least a multiplicity of basic operations in the automation language which can be used in a control program to be accessed, for the transformation rule to allow an input parameter list to be processed and, if a transformation rule is called with an input parameter list having a plurality of input parameters, unlimited in the transformation rule, for the transformation rule to define the inclusion of a further transformation rule, wherein the further transformation rule defines a recursive inclusion of the further transformation rule according to a number of the input parameters.

The advantage of the invention is first of all already the fact that, with the use of the specification database, the transformation rules are no longer necessarily part of the compiler. The specification database can actually be in the form of a distributed specification database in the individual case, where a first part of the specification database forms part of the compiler and a second part of the specification database not is included in the compiler but is made available such that the compiler gains access to this part of the specification database at any time. The further description is continued for a specification database which, in its entirety, is not included in the compiler. If the subsequent description is affected, there is systematically no difference between the two disclosed embodiment because the main point is that at least one part of the specification database is not included in the compiler and can thus also be changed independently of the compiler, with the result that the specification database or a part of the specification database not included in the compiler can be supplemented or modified at any time.

Another advantage of the invention is the fact that the transformation rule allows an input parameter list to be processed, to be precise specifically also those input parameter lists having an unlimited plurality of input parameters. A transformation rule having an unlimited plurality of input parameters is provided in the specification database as the basis for transformation of a basic operation that can likewise have an unlimited plurality of parameters. A logic AND function that is known to allow a fundamentally unlimited number of parameters to be combined may serve as an example of such a basic operation.

In such a scenario, in order to convert a basic operation having a plurality of parameters, provision is made for the respective transformation rule to be called with an input parameter list in which all parameters provided for the basic operation are combined. In order to enable this, i.e., in order to allow a previously unknown number of parameters to be transferred to the respective transformation rule, provision is made for the respective number of input parameters to be unlimited in the transformation rule. In addition, in order to process the parameters which have been transferred, the transformation rule defines the inclusion of a further transformation rule and this further transformation rule in turn defines the inclusion of the same further transformation rule according to a number of the parameters of the underlying basic operation. In this case, the transformation rule called first can be regarded as an outer transformation rule and the further transformation rule included in this outer transformation rule can accordingly be regarded as an inner transformation rule. Starting from the outer transformation rule, the inner transformation rule is therefore included according to the number of input parameters transferred to the outer transformation rule with the unlimited input parameter list. The functionality of the underlying basic operation is then actually implemented in the further, inner transformation rule.

An embodiment of the method provides for a transformation rule with a plurality of input parameters, unlimited in the transformation rule, to comprise, in the further, inner transformation rule intended to be included, at least one first and one second implementation block, where at least one first implementation block defines translation of the underlying basic operation for a case of a fixed number of input parameters, and where the second implementation block defines translation of the underlying basic operation for the case of a plurality of input parameters. In this case, at least the second implementation block comprises the recursive inclusion of the same further, inner transformation rule. For example, a first implementation block may therefore be provided for handling a situation with precisely one input parameter, a further first implementation block may be provided for handling a situation with precisely two input parameters, for example, and yet another first implementation block may be provided for handling a situation with precisely three input parameters, for example.

A particular embodiment of the method provides for a transformation rule with a plurality of input parameters, unlimited in the transformation rule, to comprise, in the further, inner transformation rule intended to be included, at least one first and one second implementation block, where the first implementation block defines translation of the underlying basic operation for the case of precisely one input parameter, and where the second implementation block defines translation of the underlying basic operation for the case of a plurality of input parameters and comprises the recursive inclusion of the same further, inner transformation rule.

Referring to the transformation rules involved in the conversion of a basic operation with a number of parameters that is not predetermined as the transformation rule and further transformation rule or outer transformation rule and inner transformation rule is intended to facilitate understanding. Referring to the transformation rule that is involved first as the outer transformation rule is actually justified by the fact that the conversion of the basic operation into the intermediate code first of all uses this outer transformation rule. With regard to the compiler that accesses the specification database, this use of the outer transformation rule may also be understood as a call of the outer transformation rule in the specification database. The outer transformation rule itself defines a further transformation rule needed to actually convert the underlying basic operation, i.e., the inner transformation rule. This designation as an inner transformation rule does not necessarily mean that the inner transformation rule is included in the outer transformation rule in the manner of a subroutine or the like, but rather is intended to define only the hierarchical dependence of the two transformation rules. The inner transformation rule is thus never directly called by the compiler but rather only when an outer transformation rule defines a need to call such an inner transformation rule. The inner transformation rule is provided for a recursive call, and such a recursive call is performed as often as required by the number of parameters of the originally underlying basic operation and thus the number of input parameters transferred to the outer transformation rule.

In order to implement the inner transformation rule, provision is made for the inner transformation rule to comprise a first and a second implementation block, and for the first implementation block to define translation of the underlying basic operation for the case of precisely one input parameter. The second implementation block is then provided for the translation of the underlying basic operation for the case of a plurality of input parameters and comprises the recursive inclusion of the respective inner transformation rule, i.e., the repeated call of the inner transformation rule itself according to the respective number of parameters.

In another particular embodiment of the method, each transformation rule is defined in the specification database in a machine-readable code, i.e., an XML code. Such a machine-readable code in the specification database has the advantage that the compiler can directly process the specification database and the definitions of transformation rules stored there. If an XML code is used as the machine-readable code, the advantage arises that, on the one hand, such an XML code is machine-readable but, on the other hand, can still also be understood by an experienced programmer, with the result that manual changes to the definition of the transformation rules in the specification database also remain possible.

The abovementioned object is also achieved with a development environment for creating and maintaining control programs as an automation solution for a technical process to be controlled, by virtue of such a development environment comprising an implementation of the method described here and below with a possibility of accessing a specification database that comprises a respective transformation rule for at least a multiplicity of basic operations in the automation language which can be used in a control program. In this respect, the invention is implemented using software and thus also relates to a computer program having program code means for carrying out all steps for implementing the method and individual refinements, if appropriate, when the computer program, i.e., a development environment of the type mentioned above or a subfunctionality of such a development environment, for example, is executed on a programming device for creating and maintaining control programs as an automation solution for a technical process to be controlled.

It is also an object of the invention to provide a programming device for creating and maintaining control programs as an automation solution for a technical process to be controlled, where the programming device includes, in a manner known per se, a processing unit in the form of or in the style of a microprocessor and a memory, where a computer program as outlined above and described with further details below is loaded into the memory, which program is executed by the processing unit during operation of the programming device.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is explained in more detail below with reference to the drawing. Items or elements which correspond to one another have been provided with the same reference symbols in all figures, in which:

FIG. 1 shows a conventional automation system for controlling a technical process according to a control program created using a development environment provided for this purpose;

FIG. 2 shows a control program in a source code with a plurality of basic operations of an automation language used in each case, then a control program in an intermediate code with a sequence of instructions which respectively maps a basic operation in an intermediate language, and finally a control program in a machine language in accordance with the invention;

FIG. 3 shows a graphical illustration of mapping of a basic operation to a sequence of instructions in the intermediate language using a transformation rule in accordance with the invention;

FIG. 4 shows a graphical illustration of a development environment with an editor and a compiler, the development environment, specifically its compiler, having access to a specification database having a plurality of transformation rules in accordance with the invention;

FIG. 5 shows an exemplary of a basic operation having a fundamentally unlimited number of parameters in accordance with the invention;

FIG. 6 shows a hierarchical illustration of a basic operation having a multiplicity of parameters as individual operations in accordance with the invention;

FIG. 7 shows a transformation rule for handling a special case of a basic operation with a number of parameters unknown in advance and accordingly a plurality of input parameters unlimited in the transformation rule in accordance with the invention;

FIG. 8 shows a graphical illustration of results of a recursive call of a further transformation rule included in a transformation rule of FIG. 7; and

FIG. 9 is a flowchart of the method in accordance with the invention.

### DETAILED DESCRIPTION OF THE PREFERRED EMBODIMENTS

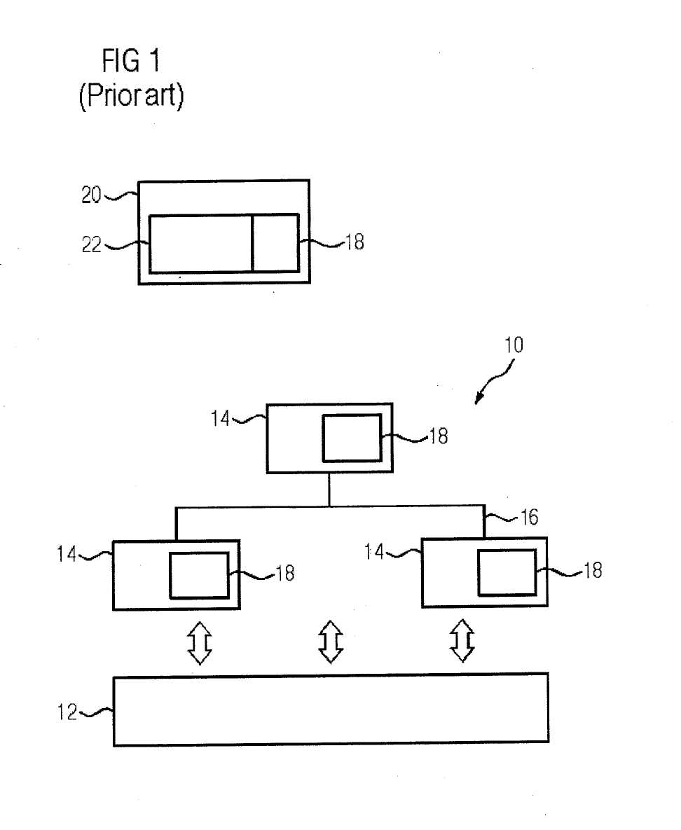

FIG. 1 schematically shows, in a highly simplified manner, a conventional automation system that is denoted overall with 10 and is intended to control and/or monitor a fundamentally arbitrary technical process 12 which is not illustrated in any more detail. The automation system 10 may comprise precisely one automation device 14 or a plurality of automation devices 14. In the case of a plurality of automation devices 14, they are usually communicatively connected in a manner known per se, for example, via a bus 16. The or each automation device 14 is intended to execute a control program 18, and the functionality of the respective control program 18 defines the manner in which the technical process 12 is influenced by the automation system 10.

A programming device 20 or a standard computer acting as a programming device is usually used to create, maintain and service such control programs 18. In order to create a control program 18, a development environment 22 is provided in this case on the programming device 20 and comprises, in a manner known per se, for example, an editor for creating the respective control program 18 and then a functionality for converting the control program 18, in particular into an executable code.

In order to illustrate that the respective control program 18 is created using the programming device 20 and, in particular, its development environment 22, the control program 18 is also illustrated in the region of the programming device 20. In actual fact, a careful distinction must be made with regard to a control program 18 on the side of the programming device 20. On the one hand, the control program 18 is located on the side of the programming device 20 in so far as a basis for the control program 18, i.e., the sequence of instructions that defines the control program 18 in the respective automation language, is held on the side of the programming device 20. On the other hand, the control program 18 may also be located, at least temporarily, on the side of the programming device 20 in a form that is executable by an automation device 14 if the basis for the control program 18 is translated by the development environment 22 and the translation result is stored or remains stored, at least temporarily, on the side of the programming device 20. In this case and in the text below, any embodiment of a control program 18 is also referred to as a control program and the context respectively indicates whether it is the control program in a source code, in an intermediate code or in an executable code.

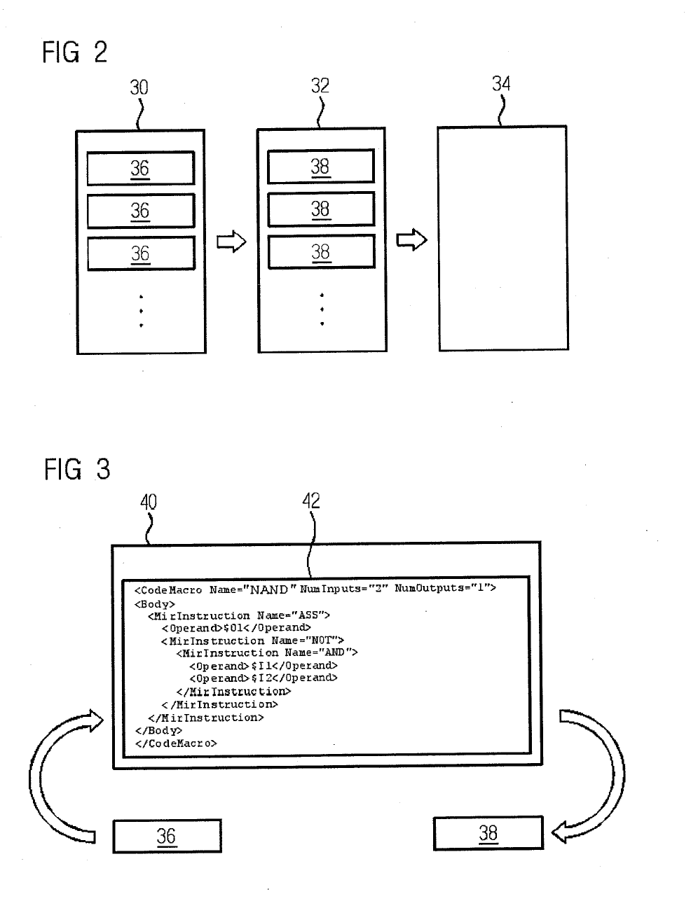

FIG. 2 shows further details of this, to be precise for a situation in which a control program 18, starting from a source code, is not directly translated into an executable code but rather into an intermediate code first. The designations “control program in a source code” and “source code” and “control program in an intermediate code” and “intermediate code” are occasionally used synonymously here and in the text below. The same applies to the “control program in the executable code” and the “executable code”.

The control program in a source code is a control program in the respective automation language. The control program in an intermediate code is the same control program with a sequence of instructions which respectively maps a basic operation in a respective intermediate language.

The illustration in FIG. 2 shows, in a first block, a graphical illustration of the control program 18 in the automation language and thus simultaneously the control program 18 in a source code. A second block arranged beside this block is a graphical illustration of the control program 18 in the intermediate language and thus simultaneously a graphical illustration of the control program 18 in an intermediate code. A third block again arranged beside this block is a graphical illustration of the control program 18 in an executable code. In order to designate these three blocks which each correspond to different states of the control program 18, the terms automation language 30, intermediate language 32 and machine language 34 are also used for short below.

FIG. 2 illustrates that, starting from the control program 18 in the automation language 30, translation or conversion into the intermediate language 32 is first of all performed and that, starting from the control program 18 in the intermediate language 32, translation or conversion into a machine language 34 that is executable by a processor of a respective automation device 14 is then performed. The creation of the control program 18 in the automation language 30 and then at least the translation or conversion into the intermediate language 32 are performed using the development environment 22 of the programming device 20. The translation or conversion into the machine language 34 can be performed using the same development environment 22 but may also be performed on another device or another software functionality provided for this purpose.

When creating the respective control program 18 in the automation language 30, the programmer uses a number of basic operations 36 that are available in the respective automation language 30 in which the source code is created. In the intermediate language 32, each basic operation 36 results in a sequence 38 of instructions in the intermediate language 32, where the sequence 38 of instructions each comprises at least one instruction in the intermediate language 32 or a plurality of instructions in the intermediate language 32. These sequences 38 of instructions in the intermediate language 32 are translated or converted then or at a given time into an executable code in a machine language 34.

In this respect, FIG. 3 schematically shows, in a simplified manner, the conversion of a basic operation 36 in the automation language 30 into a sequence 38 of instructions in the intermediate language 32. It is illustrated that, in order to translate the control program 18 in the form of a sequence of basic operations 36 in the respective automation language 30 into the intermediate language 32, a specification database 40 comprising a respective transformation rule 42 for at least a multiplicity of basic operations 36 in the automation language 30 that can be used in the control program 18 is accessed. For reasons of clarity, only one transformation rule 42 is shown in FIG. 3. Here, the transformation rule 42 shown is defined in a machine-readable code, i.e., an XML code. The transformation rule 42 is inserted again below for better legibility:

```
    <CodeMacro Name=“NAND” NumInputs=“2” NumOutputs=“1”>
<Body>
  <MirInstruction Name=“ASS”>
      <Operand>$O1</Operand>
      <MirInstruction Name=“NOT”>
          <MirInstruction Name=“AND”>
              <Operand>$I1</Operand>
              <Operand>$I2</Operand>
          </MirInstruction>
      </MirInstruction>
  </MirInstruction>
</Body>
</CodeMacro>
```

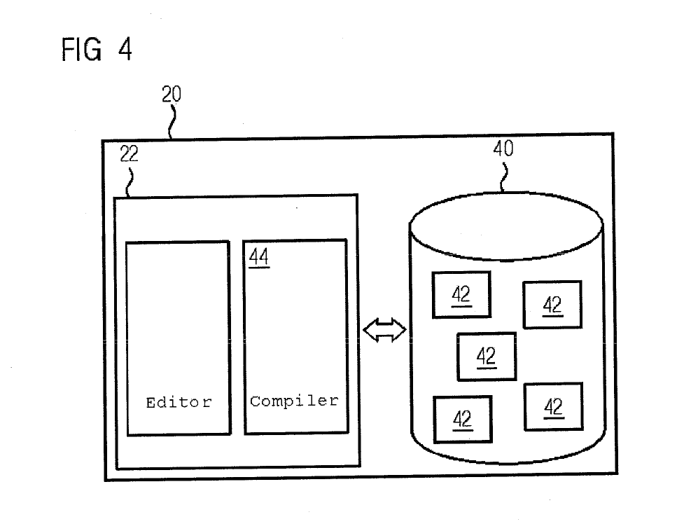

The transformation rule 42 illustrated is a rule for converting a basic operation 36 in the automation language 30 that defines a logic “NAND” function. It is seen that the transformation rule 42 divides this basic operation 36 into two separate Boolean operations, i.e., an inner AND function and an outer negation, with the result that the basic operation 36 NAND can also be readily performed by processors of automation devices 14 that do not directly implement this logic operation, for example, but can process logic AND functions and logic negations. As a result of the fact that the transformation rule 42 is held in a specification database 40, individual transformation rules 42 can be defined independently of a compiler 44 (FIG. 4) which is provided as part of a development environment 22, for example. The transformation rules 42 that are thus independent of the compiler 44 can thus be changed or supplemented at any time without needing to change the compiler 44. The functionality of the compiler 44 can thus be extended, as it were, by supplementing the specification database 40 without having to change the compiler 44 itself. The expansion of the functionality of the compiler 44 involves continuously supplementing the ability of the compiler 44 to translate particular basic operations 36 by adding further transformation rules 42 to the specification database 40.

The example which is outlined above and in which the logic operation NAND is divided into two operations also makes another advantage of the method presented here clear: the conversion into the intermediate language 32 can be performed on a target-processor-specific basis, thus making it possible to ensure that only instructions that can also be implemented by the processor of the respective automation device 14 are present in the intermediate code. Conversely, division of operations into two or more individual operations that is possibly necessary for less powerful processors can be dispensed with for particularly powerful processors if the respective processor directly supports the operation. Without restricting the powerfulness of the automation language, a favorable starting point for an intermediate code that can be easily converted into an executable code can thus be provided by using a specification database 40 appropriate for a respective target processor.

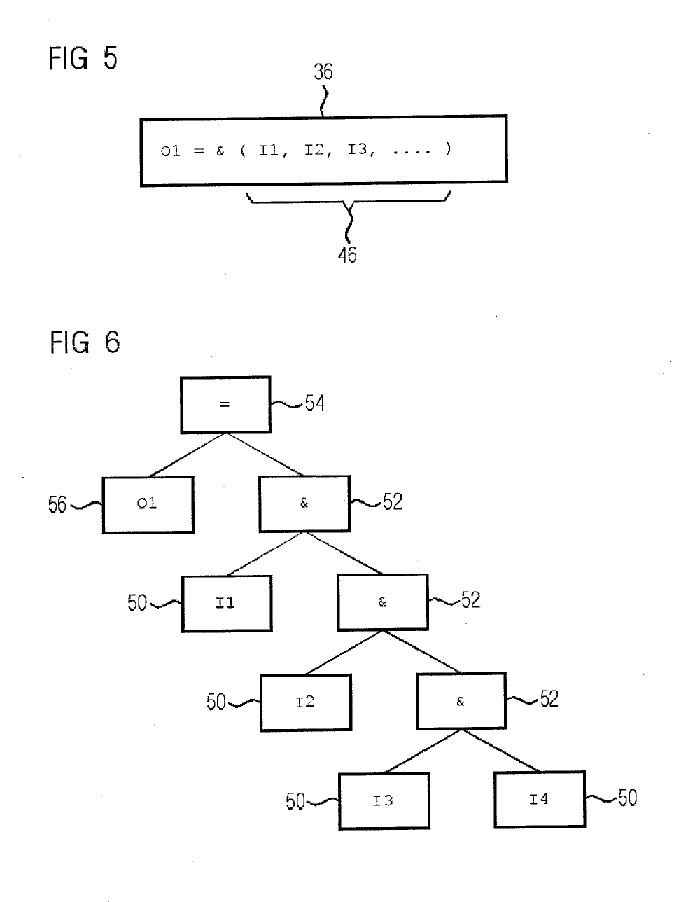

In order to explain a special aspect of the method proposed here for translating a control program 18 in an automation language 30 into an intermediate language 32, FIG. 5 now shows a special basic operation 36 of the automation language 30, i.e., a basic operation 36 having a fundamentally unlimited number of parameters. A logic AND function, which is illustrated by the symbol “&” in the illustration in FIG. 5, is shown here as an example of such a basic operation 36. The basic operation 36 is defined for a plurality of input parameters—symbolically represented as “I1”, “I2”, “I3”, etc.—and at least one output parameter—symbolically represented as “O1”. All of the input parameters are referred to as an input parameter list 46 below (the designation as an input parameter list is subsequently also used when explaining the transformation rules 42 and the parameters transferred to the latter; however, it is not possible to designate the respective input parameter list in the figures because such lists result only when processing the respective transformation rule 42).

It is easily conceivable that the conversion of a basic operation 36 with a fundamentally unlimited input parameter list 46 using a static transformation rule 42 is not trivial. This special aspect of the method presented here is resolved as follows:

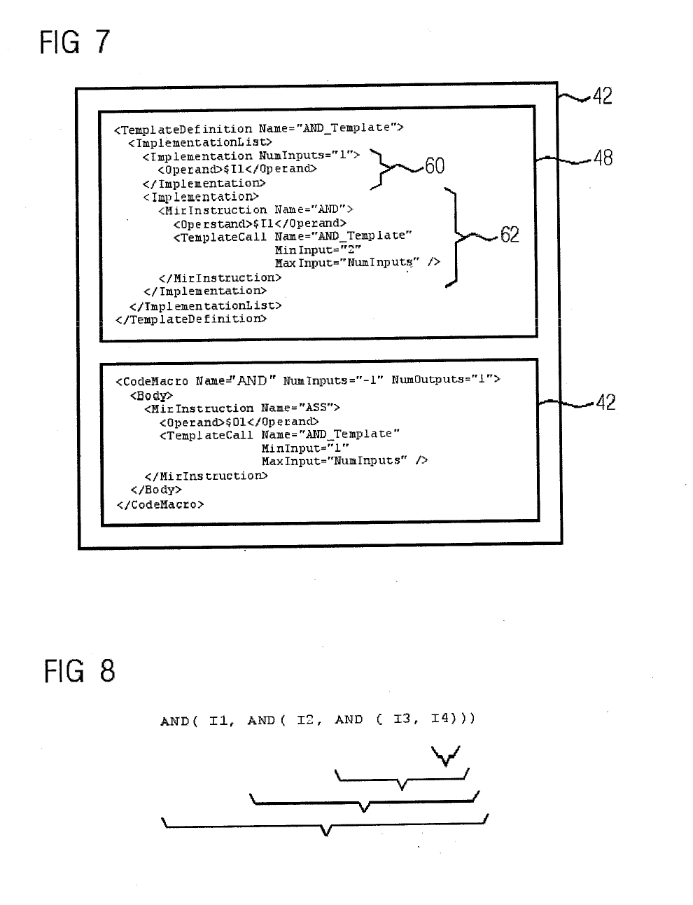

Provision is first of all made for the transformation rule 42 to allow an input parameter list 46 to be processed. When the transformation rule 42 is called with an input parameter list 46 having a plurality of input parameters, unlimited in the transformation rule 42, the transformation rule 42 defines the inclusion of a further transformation rule 48. The further transformation rule 48 defines a recursive inclusion of itself, i.e., of the further transformation rule 48, according to a number of the input parameters. For the purpose of explanation, reference is made to the illustration in FIG. 6 and FIG. 7.

FIG. 6 shows that the basic operation 36 illustrated in FIG. 5 can be regarded as a combination of operations, i.e., in the example illustrated for four input parameters 50, as a combination of a plurality of AND functions 52 and an allocation operation 54 which allocates the result of the AND functions 52 to the respective output parameter 56.

FIG. 7 shows a possible implementation of a transformation rule 42 for converting a basic operation 36, as illustrated in FIG. 5, into the intermediate language 32. The illustration that the transformation rule 42 is intended to map a basic operation 36 (FIG. 3) to a sequence 38 (FIG. 3) of instructions in the intermediate language 32 has been dispensed with in FIG. 7 and reference is made to FIG. 3 in this respect. In addition, for better legibility, the content of the transformation rule 42, as shown in FIG. 7, is copied again below:

```
    <TemplateDefinition Name=“AND_Template”>
  <ImplementationList>
      <Implementation NumInputs=“1”>
          <Operand>$I1</Operand>
      </Implementation>
      <Implementation>
          <MirInstruction Name=“AND”>
              <Operand>$I1</Operand>
              <TemplateCall Name=“AND_Template”
                  MinInput=“2”
                  MaxInput=“NumInputs” />
          </MirInstruction>
      </Implementation>
  </ImplementationList>
</TemplateDefinition>
<CodeMacro Name=“AND” NumInputs=“−1” NumOutputs=“1”>
  <Body>
      <MirInstruction Name=“ASS”>
          <Operand>$O1</Operand>
          <TemplateCall Name=“AND_Template”
              MinInput=“1”
              MaxInput=“NumInputs” />
      </MirInstruction>
  </Body>
</CodeMacro>
```

In order to convert the basic operation 36 comprising a logic AND function, a transformation rule 42 with the designation “AND” is therefore provided (see: “CodeMacro Name=“AND””). For this rule, the parameters “NumInputs” and “NumOutputs” are used to define the number of respective input and output parameters. In this case, the value “−1” for the parameter “NumInputs” means that the number of input parameters 50 is unlimited. The value “1” for the parameter “NumOutputs” means in this case that precisely one output parameter 56 is returned. By virtue of the fact that the value “−1” for the parameter “NumInputs” allows a number of input parameters 50 which is unlimited in the transformation rule 42, the transformation rule 42 can accordingly be called with an input parameter list 46 that comprises all of the parameters provided for the underlying basic operation 36.

In order to actually implement the functionality of the underlying basic operation 36, provision is made for the transformation rule 42 to define the inclusion of a further transformation rule 48. In the illustration in FIG. 7, this is symbolically expressed by “TemplateCall Name=“AND_Template”” in the transformation rule 42, wherein the name “AND_Template” (“TemplateDefinition Name=“AND_Template””) was defined as the designator of the further transformation rule 48, under which the further transformation rule 48 can be called. In this case, the call is effected with the boundary conditions MinInput=“1” and MaxInput=“NumInputs”, i.e., the specification that the first parameter in the input parameter list 46 is the first parameter in the input parameter list 46 transferred when the transformation rule 42 is called and that as many parameters as are defined by the parameter “NumInputs” are then transferred from the input parameter list 46 transferred when the transformation rule 42 is called. This causes the input parameters 50 I1, I2, I3 and I4 to be transferred when the further or inner transformation rule 48 for converting the basic operation 36 shown in FIG. 5 is called.

The further or inner transformation rule 48 is itself recursively called from the latter if required. In this case, the call (“TemplateCall Name=“AND_Template””) is effected using the name defined for the further/inner transformation rule 48 and with the boundary conditions MinInput=“2” and MaxInput=“NumInputs”. In this manner, the second parameter in the input parameter list 46 transferred when the further/inner transformation rule 48 is called is transferred as the first parameter in the input parameter list 46. As many parameters as are defined by the parameter “NumInputs” are then transferred from the input parameter list 46 transferred when the further/inner transformation rule 48 is called. This results in the further/inner transformation rule being recursively called with the following parameter lists: [I2, I3, I4], [I3, I4], [I4]. During the last recursion step, i.e., when precisely one input parameter 50 is transferred, an implementation block provided for processing precisely one input parameter 50 (“Implementation NumInputs=“1””) is called. There, the transferred parameter, namely I4, is accepted for conversion into the intermediate code (“<Operand>$I1</Operand>”). If the recursion is then canceled again, the input parameters 50 are first of all processed according to the input parameter list 46 with [I3, I4]. The input parameter 50 [I4] has already been processed in the last recursion step. In this recursion step, the logic AND function and the input parameter 50 [I3] are then added for conversion into the intermediate language (“<MirInstruction Name=“AND”>” and “<Operand>$I1</Operand>”). The input parameters 50 are then processed according to the input parameter list 46 with [I2, I3, I4]. The input parameters 50 [I3] and [I4] have already been processed in preceding recursion steps. In this recursion step, the logic AND function and the input parameter 50 [I2] are then added again for conversion into the intermediate language (“<MirInstruction Name=“AND”>” and “<Operand>$I1</Operand>”). The conversion into the intermediate code is then carried out on the basis of the original, non-recursive call of the further/inner transformation rule 48, i.e., according to the input parameter list 46 with [I1, I2, I3, I4]. In this case, the logic AND function and the input parameter 50 [I1] are added again (“<MirInstruction Name=“AND”>” and “<Operand>$I1</Operand>”). The result in the intermediate code is accordingly, for example, as follows: AND (I1, AND (I2, AND (I3, I4))). This is illustrated again in FIG. 8 below FIG. 7 and the overlapping curly brackets (not designated) represent the result of the recursion steps, where the smallest bracket under I4 symbolizes the last but first fully executed recursion step.

If the calls of the further/inner transformation rule 48 and the recursion have been concluded, the conversion into the intermediate code is performed according to the definition in the (outer) transformation rule 42. The latter defines that the allocation operation 54 (“<MirInstruction Name=“ASS”>”) acts on the output parameter (“<Operand>$O1</Operand>”) specified in the parameter list, thus resulting in the AND functions, which are canceled by calling the further/inner transformation rule 48, being allocated to the output parameter 56 O1.

The transformation rule 42 just described and the associated further/inner transformation rule 48 may also be regarded together as a transformation rule 42 with an outer transformation rule 42 and the further transformation rule 48 as an inner transformation rule. In the illustration in FIG. 7, the two transformation rules 42, 48 are therefore included in a block which is itself also referred to as a transformation rule 42.

In the illustrated implementation of the further/inner transformation rule 48, a special feature also exists with regard to the handling of a situation with precisely one input parameter and situations with a plurality of input parameters 50. A first and a second implementation block 60, 62 are respectively provided for this purpose. The first implementation block 60 is provided for handling a situation with precisely one input parameter 50 (“Implementation NumInputs=“1””) and defines translation or conversion of the underlying basic operations 36 or a partial aspect of the underlying basic operations 36 for the case of precisely one input parameter 50. The second implementation block 62, likewise beginning with the keyword “Implementation”, is provided for handling all other situations, i.e., situations with more than one input parameter 50, and defines translation or conversion of the underlying basic operations 36 or a partial aspect of the underlying basic operations 36 for the case of a plurality of input parameters 50. In this case, the second implementation block 62 comprises the recursive inclusion of the further transformation rule 48. In addition to the illustrated embodiment with precisely one first and one second implementation block 60, 62, further implementation blocks may also be provided, i.e., at least one implementation block for a respectively fixed number of input parameters 50 and an implementation block for a variable number of input parameters 50. The situation described is thus a special case of this more general situation in which the fixed number of input parameters is precisely “one” and in which no further implementation block is provided for a respectively fixed number of input parameters and in which the second implementation block is provided for a variable number of input parameters 50.

If the text here refers to translation or conversion of the underlying basic operations 36 or a partial aspect of the underlying basic operations 36, this takes into account the illustrated example in which the further/inner transformation rule 48 implements the repeated AND function and the outer transformation rule 42, in addition to calling the further/inner transformation rule 48, only implements allocation to the output parameter provided according to the underlying basic operation 36. Irrespective of whether the further/inner transformation rule 48 possibly defines only a partial aspect of the translation or conversion of the underlying basic operations 36, the definition of translation or conversion of such a partial aspect is also still at least part of a definition of translation or conversion of the underlying basic operation 36, with the result that the wording as a partial aspect must not be interpreted at all as being restrictive.

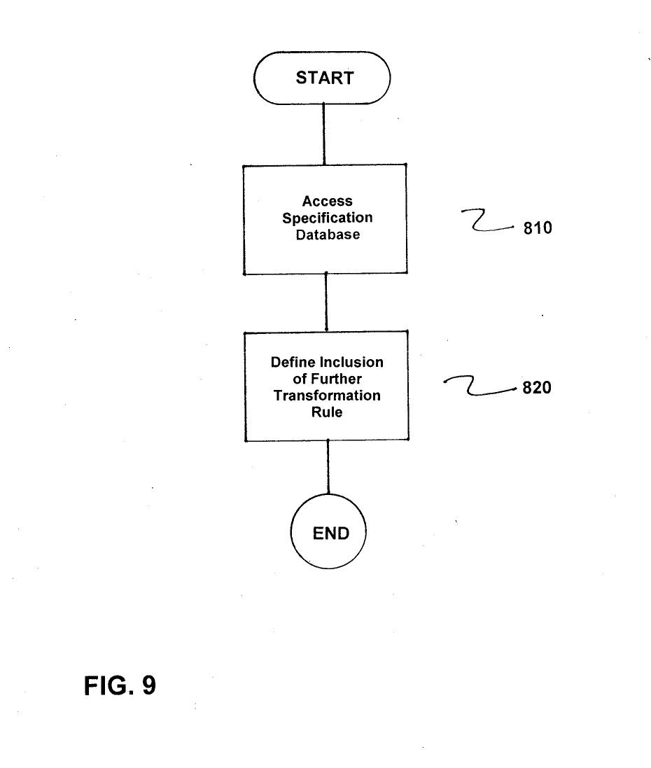

FIG. 9 is a flowchart of a computer implemented method for automatically translating a control program in an automation language into an intermediate language, where the control program comprises a plurality of basic operations automatically mapped to a respective sequence of instructions in the intermediate language. The method comprises accessing, by a processor of the computer, a specification database comprising a respective transformation rule for at least a multiplicity of basic operations in the automation language which is useable in the control program to translate the control program into the intermediate language, as indicated in step 810. Here, the respective transformation rule allows an input parameter list to be processed. An inclusion of a further transformation rule is then defined with the transformation rule if the transformation rule is called with an input parameter list having a plurality of input parameters, unlimited in the transformation rule, as indicated in step 820. Here, the further transformation rule defines a recursive inclusion of the further transformation rule according to a number of the plurality of input parameters.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer implemented method for automatically translating a control program in an automation language into an intermediate language, wherein the control program comprises a plurality of basic operations automatically mapped to a respective sequence of instructions in the intermediate language, the method comprising the steps of:
accessing, by a processor of the computer, a specification database comprising a respective transformation rule for at least a multiplicity of basic operations in the automation language which is useable in the control program to translate the control program into the intermediate language, the respective transformation rule allowing an input parameter list to be processed; and
defining with the transformation rule an inclusion of a further transformation rule if the transformation rule is called with an input parameter list having a plurality of input parameters, unlimited in the transformation rule;
wherein the further transformation rule defines a recursive inclusion of the further transformation rule according to a number of the plurality of input parameters.

2. The method as claimed in claim 1, wherein a transformation rule with the plurality of input parameters, unlimited in the transformation rule comprises, in the further transformation rule intended to be included, at least one first and one second implementation block;
wherein the at least one first implementation block defines translation of underlying basic operations for a fixed number of input parameters;
wherein the at least one second implementation block defines translation of the underlying basic operations for a variable number of input parameters; and
wherein the at least one second implementation block comprises a recursive inclusion of the further transformation rule.

3. The method as claimed in claim 1, wherein a transformation rule with a plurality of input parameters, unlimited in the transformation rule comprises, in the further transformation rule intended to be included, at least one first and one second implementation block;
wherein the at least one first implementation block defines translation of underlying basic operations for precisely one input parameter; and
wherein the at least one the second implementation block defines translation of the underlying basic operations for the plurality of input parameters and comprises a recursive inclusion of the further transformation rule.

4. The method as claimed in claim 2, wherein a transformation rule with a plurality of input parameters, unlimited in the transformation rule comprises, in the further transformation rule intended to be included, at least one first and one second implementation block;
wherein the at least one first implementation block defines translation of the underlying basic operations for precisely one input parameter; and
wherein the at least one second implementation block defines translation of the underlying basic operations for the plurality of input parameters and comprises a recursive inclusion of the further transformation rule.

5. The method as claimed in claim 1, wherein each transformation rule is defined in the specification database in a machine-readable code.

6. The method as claimed in claim 2, wherein each transformation rule is defined in the specification database in a machine-readable code.

7. The method as claimed in claim 3, wherein each transformation rule is defined in the specification database in a machine-readable code.

8. The method as claimed in claim 5, wherein the machine-readable code comprises an XML code.

9. A process in which a computer executes instructions set forth in a development environment executing on a processor for creating and maintaining control programs as an automation solution for a technical process to be controlled which, when used on the computer, causes the processor to automatically translate a control program in an automation language into an intermediate language, the control program comprising a plurality of basic operations automatically mapped to a respective sequence of instructions in the intermediate language, the development environment comprising:
program code for accessing a specification database comprising a respective transformation rule for at least a multiplicity of basic operations in the automation language which is useable in the control program to translate the control program into the intermediate language, the respective transformation rule allowing an input parameter list to be processed; and
program code for defining with the transformation rule an inclusion of a further transformation rule if the transformation rule is called with an input parameter list having a plurality of input parameters, unlimited in the transformation rule;
wherein the further transformation rule defines a recursive inclusion of the further transformation rule according to a number of the plurality of input parameters.

10. A computer program stored in a storage device which, when executed on a processor of a programming device for creating and maintaining control programs as an automation solution for a technical process to be controlled, causes the processor to automatically translate a control program in an automation language into an intermediate language, the control program comprising a plurality of basic operations automatically mapped to a respective sequence of instructions in the intermediate language, the computer program comprising:
program code for accessing a specification database comprising a respective transformation rule for at least a multiplicity of basic operations in the automation language which is useable in the control program to translate the control program into the intermediate language, the respective transformation rule allowing an input parameter list to be processed; and
program code for defining with the transformation rule an inclusion of a further transformation rule if the transformation rule is called with an input parameter list having a plurality of input parameters, unlimited in the transformation rule;
wherein the further transformation rule defines a recursive inclusion of the further transformation rule according to a number of the plurality of input parameters.

11. A programming device for creating and maintaining control programs as an automation solution for a technical process to be controlled, the comprising:
a processor; and
a memory storing a computer program;
wherein the computer program comprises:
program code for accessing a specification database comprising a respective transformation rule for at least a multiplicity of basic operations in the automation language which is useable in a control program to translate the control program into an intermediate language, the respective transformation rule allowing an input parameter list to be processed; and
program code for defining with the transformation rule an inclusion of a further transformation rule if the transformation rule is called with an input parameter list having a plurality of input parameters, unlimited in the transformation rule; and
wherein the further transformation rule defines a recursive inclusion of the further transformation rule according to a number of the plurality of input parameters;
wherein the computer program is executed by the processing unit during operation of the programming device.
